(19) United States
(12) Patent Application Publication
(10) Pub. No.: US 2012/0182252 A1
(43) Pub. Date: Jul. 19, 2012

(54) Differential Capacitive Touchscreen or Touch Panel

(75) Inventors: Michael Brosnan, Fremont, CA (US); Kenneth Crandall, Sunnyvale, CA (US)

(73) Assignee: Avago Technologies ECBU IP (Singapore) Pte. Ltd., Fort Collins, CO (US)

(21) Appl. No.: 13/007,995

(22) Filed: Jan. 17, 2011

(51) Int. Cl. G06F 3/045

(52) U.S. Cl. 345/174

(57) ABSTRACT

Various embodiments of differential cells for touchscreens or touch panels in capacitive sensing systems are disclosed. The differential circuit topologies of individual cells forming an array of such cells in a touchscreen or touch panel are configured to cancel common mode noise appearing on the multiple sense lines contained in each cell, and can result in lower power consumption, enhanced touch or near-touch sensitivity for a touchscreen or touch panel, and increased immunity from noise.

### FIELD OF THE INVENTION

Various embodiments of the invention described herein relate to the field of capacitive sensing input devices generally, and more specifically to cell geometries and circuit topologies in capacitive touchscreens and touch panels.

### BACKGROUND

Two principal capacitive sensing and measurement technologies are currently employed in most touchpad and touchscreen devices. The first such technology is that of self-capacitance. Many devices manufactured by SYNAPTICS™ employ self-capacitance measurement techniques, as do integrated circuit (IC) devices such as the CYPRESS PSOC.™ Self-capacitance involves measuring the self-capacitance of a series of electrode pads using techniques such as those described in U.S. Pat. No. 5,543,588 to Bisset et al. entitled “Touch Pad Driven Handheld Computing Device” dated Aug. 6, 1996.

Self-capacitance may be measured through the detection of the amount of charge accumulated on an object held at a given voltage (Q=CV). Self-capacitance is typically measured by applying a known voltage to an electrode, and then using a circuit to measure how much charge flows to that same electrode. When external objects are brought close to the electrode, additional charge is attracted to the electrode. As a result, the self-capacitance of the electrode increases. Many touch sensors are configured such that the grounded object is a finger grounded through the human body, where the body is essentially a capacitor to a surface where the electric field vanishes, and typically has a capacitance of around 100 pF.

Electrodes in self-capacitance touchpads are typically arranged in rows and columns. By scanning first rows and then columns the locations of individual mutual capacitance changes induced by the presence of a finger, for example, can be determined. To effect accurate multi-touch measurements in a touchpad, however, it may be required that several finger touches be measured simultaneously. In such a case, row and column techniques for self-capacitance measurement can lead to inconclusive results.

One way in which the number of electrodes can be reduced in a self-capacitance system is by interleaving the electrodes in a saw-tooth pattern. Such interleaving creates a larger region where a finger is sensed by a limited number of adjacent electrodes allowing better interpolation, and therefore fewer electrodes. Such patterns can be particularly effective in one dimensional sensors, such as those employed in IPOD click-wheels. See, for example, U.S. Pat. No. 6,879,930 to Sinclair et al. entitled Capacitance touch slider dated Apr. 12, 2005.

The second primary capacitive sensing and measurement technology employed in touchpad and touchscreen devices is that of mutual capacitance, where measurements are performed using a crossed grid of electrodes. See, for example, U.S. Pat. No. 5,861,875 to Gerpheide entitled “Methods and Apparatus for Data Input” dated Jan. 19, 1999. Mutual capacitance technology is employed in touchpad devices manufactured by CIRQUE™. In mutual capacitance measurement, capacitance is measured between two conductors, as opposed to a self-capacitance measurement in which the capacitance of a single conductor is measured, and which may be affected by other objects in proximity thereto.

Many currently-available touch controllers and touch panels perform single-ended mutual capacitance measurements. When common mode noise or display noise couples with the touchscreen or touch panel, it is detected by the single-ended measurement circuitry and can cause excess jitter and false touches. Current solutions to this well known problem include using higher drive voltages (which generally requires that additional external electronic components be provided around ad near the touch controller), and filtering sensed mutual capacitance signals with narrow pass-band filters (which can slow the response time of touchscreen systems significantly). For example, liquid crystal displays (“LCDs”) are often placed in very close proximity to capacitive touchscreens (e.g., within tenths of a millimeter), and can cause significant amounts of common mode noise to be capacitively coupled to such touchscreens.

What is needed is a capacitive measurement or sensing circuit or system that provides good immunity from common mode noise and display interference while maintaining fast response times, employing fewer external support components than would otherwise be required when boosting drive voltages, and without using integrated circuit processes that are configured to withstand relatively high voltages (e.g., 10 volts or higher).

### SUMMARY

In one embodiment, there is a provided A capacitive touchscreen or touch panel system comprising a touchscreen comprising a first plurality of electrically conductive drive electrodes arranged in rows or columns, and a second plurality of electrically conductive sense electrodes arranged in rows or columns arranged at an angle with respect to the rows or columns of the first plurality of electrodes, mutual capacitances existing between the first and second pluralities of electrodes at locations where the first and second pluralities of electrodes intersect to form individual cells, the mutual capacitances changing in the presence of one or more fingers or touch devices brought into proximity thereto, drive circuitry operably connected to the first plurality of drive electrodes, and differential voltage sense circuitry operably connected to the second plurality of sense electrodes, wherein at least some of the individual cells each comprise first and second drive electrodes and first and second sense electrodes corresponding thereto, the first and second drive electrodes being driven by a drive signal delivered thereto by the drive circuitry, the first and second sense electrodes being operably and separately connected to corresponding first and second input terminals of first and second amplifier circuits forming a portion of the sense circuitry, first and second sense signals appearing on the first and second sense electrodes in response to the drive signal being provided to the first and second drive electrodes, the sense circuitry further being configured to differentially combine first and second outputs provided by the first and second amplifier circuits and thereby cancel substantially common mode noise components present in the drive signal.

In another embodiment, there is provided a method of detecting touches or near-touches on a capacitive touchscreen or touch panel system comprising a touchscreen comprising a first plurality of electrically conductive drive electrodes arranged in rows or columns, and a second plurality of electrically conductive sense electrodes arranged in rows or columns arranged at an angle with respect to the rows or columns of the first plurality of electrodes, mutual capacitances existing between the first and second pluralities of electrodes at locations where the first and second pluralities of electrodes intersect to form individual cells, the mutual capacitances changing in the presence of one or more fingers or touch devices brought into proximity thereto, drive circuitry operably connected to the first plurality of drive electrodes, and differential voltage sense circuitry operably connected to the second plurality of sense electrodes, wherein at least some of the individual cells each comprise first and second drive electrodes and first and second sense electrodes corresponding thereto, the first and second drive electrodes being driven by a drive signal delivered thereto by the drive circuitry, the first and second sense electrodes being operably and separately connected to corresponding first and second input terminals of first and second amplifier circuits forming a portion of the sense circuitry, first and second sense signals appearing on the first and second sense electrodes in response to the drive signal being provided to the first and second drive electrodes, the sense circuitry further being configured to differentially combine first and second outputs provided by the first and second amplifier circuits and thereby cancel substantially common mode noise components present in the drive signal, the method comprising sensing at least one touch or near touch of a finger, finger portion, hand or hand portion brought into proximity to the touchscreen.

Further embodiments are disclosed herein or will become apparent to those skilled in the art after having read and understood the specification and drawings hereof.

### BRIEF DESCRIPTION OF THE DRAWINGS

Different aspects of the various embodiments will become apparent from the following specification, drawings and claims in which:

FIG. 1 shows a cross-sectional view of one embodiment of a capacitive touchscreen system;

FIG. 2 shows a block diagram of a capacitive touchscreen controller;

FIG. 3 shows one embodiment of a block diagram of a capacitive touchscreen system and a host controller;

FIG. 4 shows a schematic block diagram of one embodiment of a capacitive touchscreen system;

FIG. 5 shows one embodiment of a single differential cell or circuit 150;

FIG. 6 shows one embodiment a single differential cell 150 as schematically illustrated in FIG. 5;

FIG. 7 shows one embodiment of a touchscreen or touch panel 90 comprising an array of individual differential cells 150a through 158p;

FIG. 8 shows a magnified portion of touchscreen or touch panel 90 of FIG. 7, and

FIG. 9 shows a schematic representation of one embodiment of a single differential cell 150.

The drawings are not necessarily to scale. Like numbers refer to like parts or steps throughout the drawings.

### DETAILED DESCRIPTIONS OF SOME EMBODIMENTS

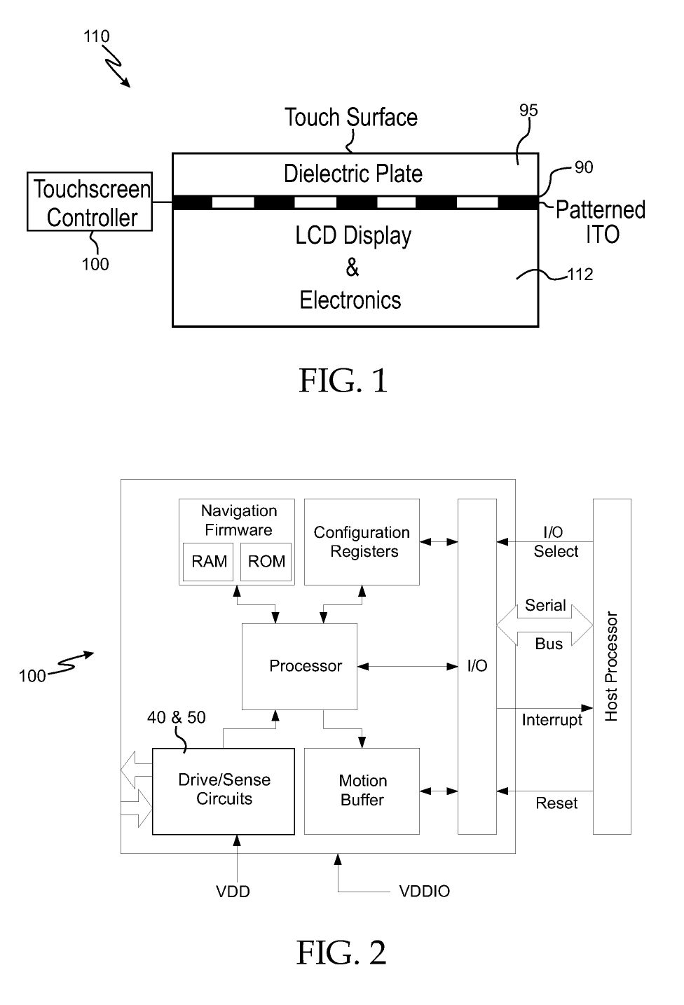

As illustrated in FIG. 1, a capacitive touchscreen system 110 typically consists of an underlying LCD or OLED display 112, an overlying touch-sensitive panel or touchscreen 90, a protective cover or dielectric plate 95 disposed over the touchscreen 90, and a touchscreen controller, micro-processor, application specific integrated circuit (“ASIC”) or CPU 100. Note that image displays other than LCDs or OLEDs may be disposed beneath touchscreen 90.

FIG. 2 shows a block diagram of one embodiment of a touchscreen controller 100. In one embodiment, touchscreen controller 100 may be an Avago Technologies™ AMRI-5000 ASIC or chip 100 modified in accordance with the teachings presented herein. In one embodiment, touchscreen controller is a low-power capacitive touch-panel controller designed to provide a touchscreen system with high-accuracy, on-screen navigation.

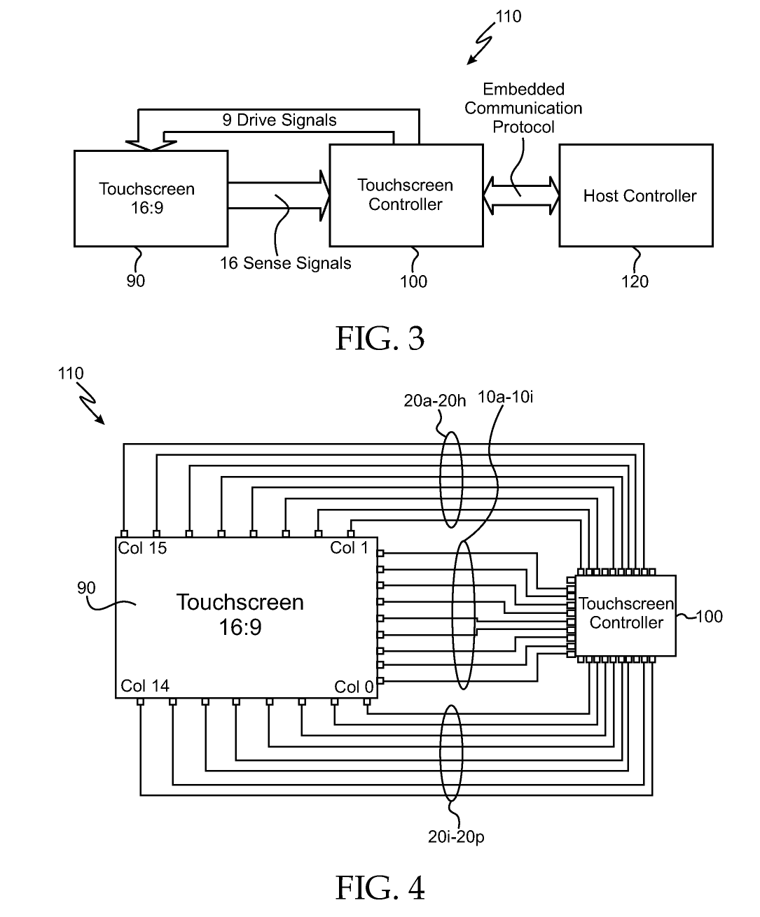

Capacitive touchscreens or touch panels 90 shown in FIGS. 3 and 4 can be formed by applying a conductive material such as Indium Tin Oxide (ITO) to the surface(s) of a dielectric plate, which typically comprises glass, plastic or another suitable electrically insulative and preferably optically transmissive material, and which is usually configured in the shape of an electrode grid. The capacitance of the grid holds an electrical charge, and touching the panel with a finger presents a circuit path to the user's body, which causes a change in the capacitance.

Touchscreen controller 100 senses and analyzes the coordinates of these changes in capacitance. When touchscreen 90 is affixed to a display with a graphical user interface, on-screen navigation is possible by tracking the touch coordinates. Often it is necessary to detect multiple touches. The size of the grid is driven by the desired resolution of the touches. Typically there is an additional cover plate 95 to protect the top ITO layer of touchscreen 90 to form a complete touch screen solution (see, e.g., FIG. 1).

One way to create a touchscreen 90 is to apply an ITO grid on one side only of a dielectric plate or substrate. When the touchscreen 90 is mated with a display there is no need for an additional protective cover. This has the benefit of creating a thinner display system with improved transmissivity (>90%), enabling brighter and lighter handheld devices. Applications for touchscreen controller 100 include, but are not limited to, smart phones, portable media players, mobile internet devices (MIDs), and GPS devices.

Referring now to FIGS. 3 and 4, in one embodiment the touchscreen controller 100 includes an analog front end with 9 drive signal lines and 16 sense lines connected to an ITO grid on a touchscreen. Touchscreen controller 100 applies an excitation such as a square wave, meander signal or other suitable type of drive signal to the drive electrodes that may have a frequency selected from a range between about 40 kHz and about 200 kHz. The AC signal is coupled to the sense lines via mutual capacitance. Touching touchscreen or touch panel 90 with a finger alters the capacitance at the location of the touch. Touchscreen controller 100 can resolve and track multiple touches simultaneously. A high refresh rate allows the host to track rapid touches and any additional movements without appreciable delay. The embedded processor filters the data, identifies the touch coordinates and reports them to the host. The embedded firmware can be updated via patch loading. Other numbers of drive and sense lines are of course contemplated, such as 8×12 and 12×20 arrays.

Touchscreen controller 100 features multiple operating modes with varying levels of power consumption. In rest mode controller 100 periodically looks for touches at a rate programmed by the rest rate registers. There are multiple rest modes, each with successively lower power consumption. In the absence of a touch for a certain interval controller 100 automatically shifts to the next-lowest power consumption mode. However, as power consumption is reduced the response time to touches increases.

According to one embodiment, and as shown in FIG. 4, an ITO grid or other electrode configuration on touchscreen 90 comprises sense columns 20a-20p and drive rows 10a-10i, where sense columns 20a-20p are operably connected to corresponding sense circuits and rows 10a-10i are operably connected to corresponding drive circuits. One configuration for routing ITO or other drive and sense electrodes to lines to touchscreen controller 100 is shown in FIG. 4.

Those skilled in the art will understand that touchscreen controllers, micro-processors, ASICs or CPUs other than a modified AMRI-5000 chip or touchscreen controller 100 may be employed in touchscreen system 110, and that different numbers of drive and sense lines, and different numbers and configurations of drive and sense electrodes, other than those explicitly shown herein may be employed without departing from the scope or spirit of the various embodiments of the invention.

In some of the various embodiments presented herein, the number of drive and sense electrodes or lines is doubled to permit rejection of common mode signals through differential detection of voltages at individual differentially driven cells within a touchscreen or touch panel 90. As a result, at least some of the individual cells of a touchscreen or touch panel are four-port devices with two inputs and two outputs instead of conventional simple two port devices with one input and one output. Common mode rejection of noise resulting from the use of such four-port devices or cells rejects any voltage common to both inputs. It has been discovered that very strong low frequency noise signals (e.g., 0 Hz to 1 MHz) are capable of uniformly coupling capacitively to all cells in a touchscreen or touch panel 90 with respect to earth ground. The differentially driven and sensed cells disclosed herein have the significant advantage of being able to reject common mode noise signals, even in the presence of such strong low frequency noise signals.

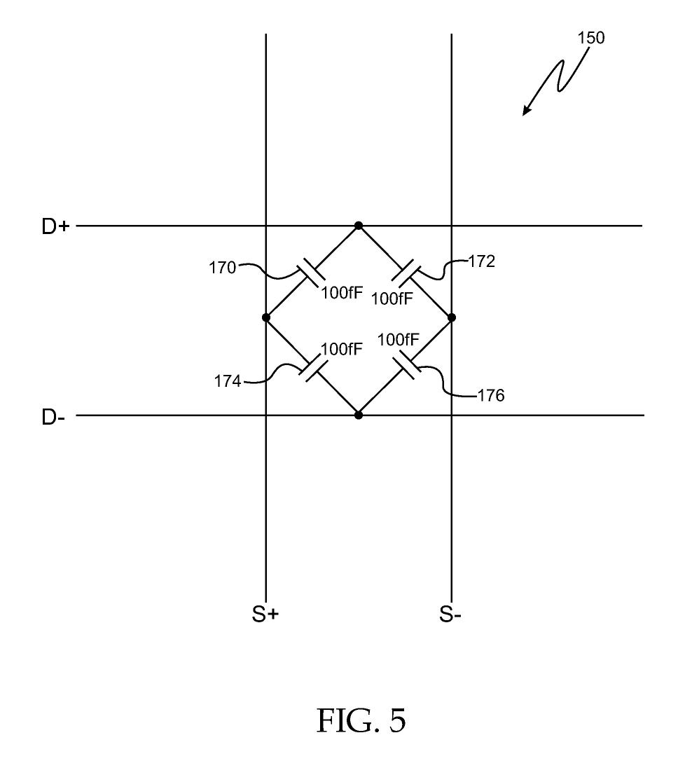

FIG. 5 shows four 100 fF capacitors (1 fF=10⁻¹⁵ Farads) 170, 172, 174 and 176 in a single differential cell or circuit 150 comprising two drive lines or electrodes D+ and D−, and two sense lines or electrodes S+ and S−. Differential cell 150 of FIG. 5 represents typical mutual capacitance coupling between two drive rows (electrodes or lines D+ and D−) and two sense rows (electrodes or lines S+ and S−). The values of capacitors 170, 172, 174 and 176 are subject to change when a finger or stylus touch comes into close proximity to cell 150. The mutual capacitance that can be sensed by cell 150 is much smaller than in conventional non-differential cell circuit topologies due to the added lines and smaller cell geometry.

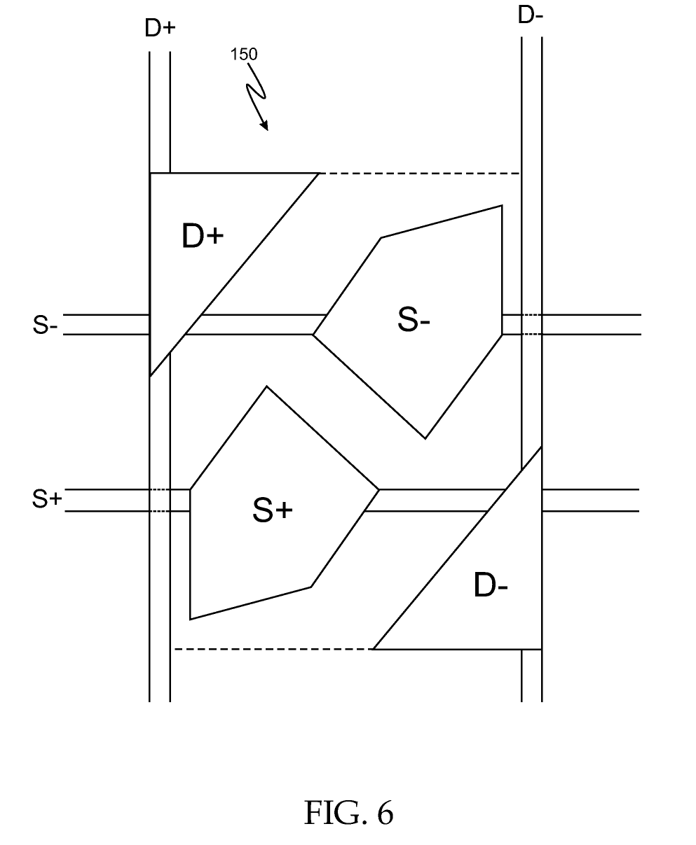

FIG. 6 shows one embodiment of a single differential cell 150 as schematically illustrated in FIG. 5 comprising two drive electrodes D+ and D− operably connected to respective drive lines, and two sense electrodes S+ and S− operably connected to sense lines. Conductive ink (typically indium tin oxide or “ITO”) can be placed in one layer to form the drive lines or electrodes, and in another layer to form the sense lines or electrodes. An insulating layer is typically employed to separate the drive and sense layers. Alternatively, both drive and sense electrodes or lines can be formed on the same layer and separated by jumpers.

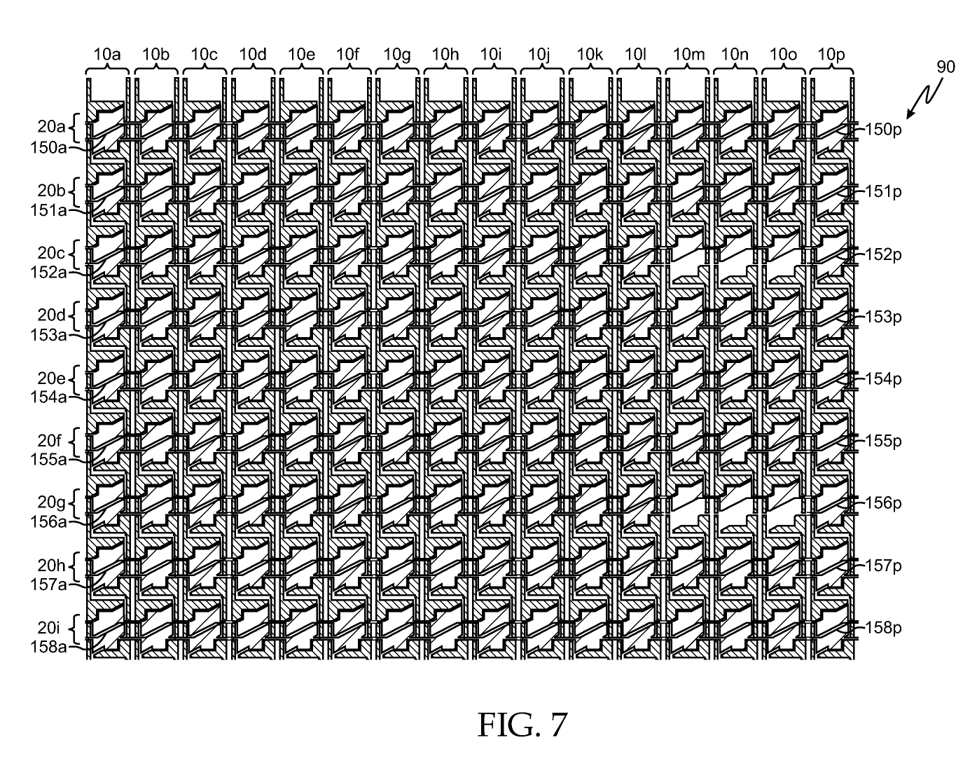

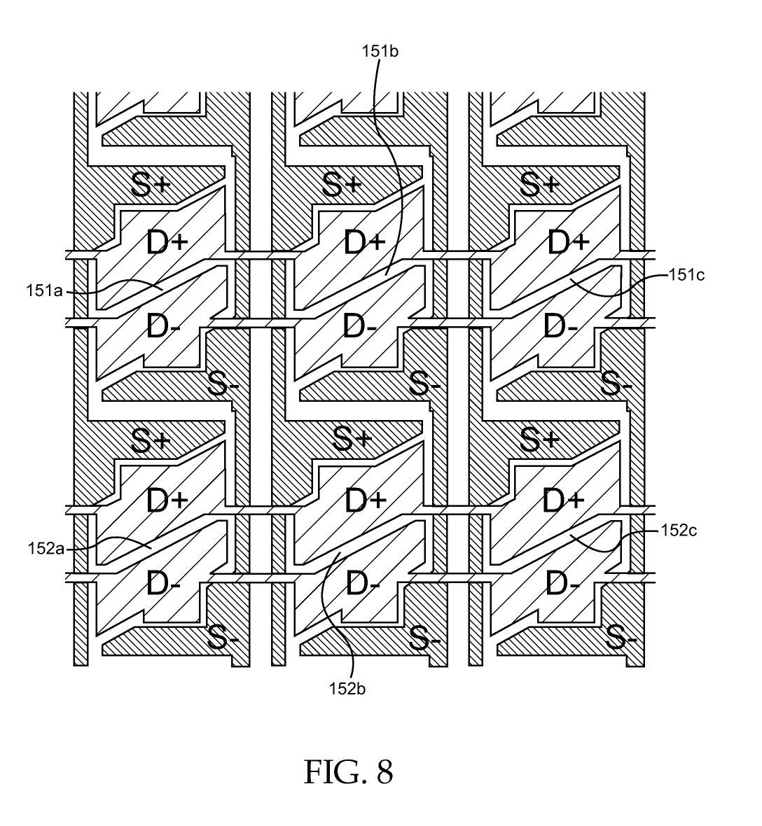

FIG. 7 shows one embodiment of a touchscreen or touch panel 90 comprising an array of individual differential cells 150a through 158p. In FIG. 7, differential cells 150a through 158p form an array of cells for touchscreen or touch panel 90. Diagonally hatched conductors in FIG. 7 are sense column lines (10a through 10p), while white conductors in FIG. 7 are row drive lines (20a through 20i). Depending on cost and other performance metrics, drive lines 20a through 20i and sense lines 10a through 10p may be interchanged or swapped around, which is permitted owing to the symmetric nature of differential cells 150a through 158p. FIG. 8 shows a magnified portion of touchscreen or touch panel 90 of FIG. 7, where further details of individual differential cells 151a, 151b, 151c, 152a, 152b, and 152c are shown.

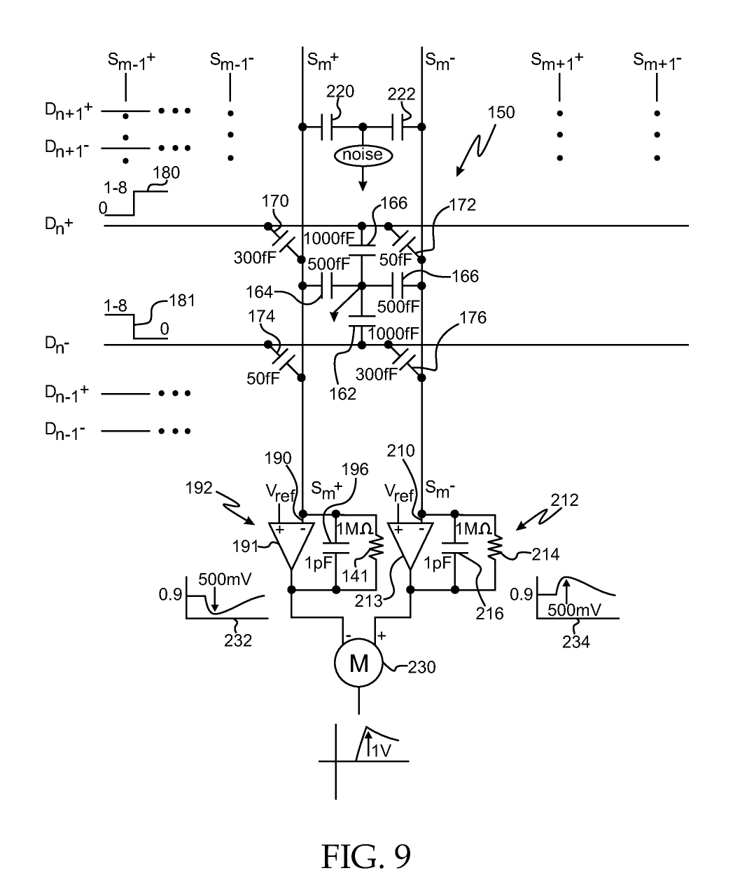

FIG. 9 shows a schematic representation of one embodiment of a single differential cell 150. Noise coupling is shown capacitively coupling between sense lines Sm+ and Sm−, and is represented as capacitances 220 and 222. The value of either of capacitances 220 and 22 typically varies between about 2 pF and about 100 pF, depending on the proximity of touchscreen or touch panel 90 to the noise source, and the nature or type of the noise source. As mentioned above, LCDs are often placed only a few tenths of a millimeter from a touchscreen or touch panel 90, and can generate very large coupling capacitances. Other sources of noise may couple via the human body and couple to a display through an area of touch or near-touch contact on touchscreen or touch panel 90, with correspondingly small capacitive coupling (perhaps 2 pF typically). The magnitude of the capacitively coupled noise can vary from a few volts (LCD drive voltages) to 50 or more volts for power line coupling and florescent light sources. Common mode noise originating from battery charging activities can also be conducted through a touch contact on touchscreen or touch panel 90 to earth ground, and have magnitudes in the tens of volts.

Shunt capacitances are shown in the center of FIG. 9 with two 500 fF capacitors and two 1000 fF capacitors connecting to signal ground (see capacitances 162, 164, 166 and 168 in FIG. 9). These capacitances are charged to Vref through the action of negative feedback on inverting operational amplifier inputs 190 and 210.

In FIG. 9, mutual capacitances 170, 172, 174 and 176 in FIG. 9 have values of 300 fF and 50 fF. Such an out-of-balance condition creates a differential on the two operational amplifier output lines. Since the noise appears equally on the two sense lines for differential cell 150, they have zero difference respecting one another and as a result cancel out. According to one embodiment, a magnitude of the common mode noise may range between about 2 pF and about 100 pF.

Continuing to refer to FIG. 9, note that first and second amplifier circuits 192 and 212 may comprise first and second operational amplifiers 191 and 213, respectively, or may comprise any other suitable type of amplifier, such as a transconductance amplifier. In one embodiment, and as shown in FIG. 9, the first and second inputs of differential cell 150 are provided to inverting inputs 190 and 210 of first and second operational amplifiers 191 and 213, respectively. A reference voltage Vref is provided to positive inputs of the first and second operational amplifiers 191 and 213, respectively. As further shown in FIG. 9, first and second operational amplifier circuits 192 and 212 are each configured as integrating circuits comprising first and second feedback capacitors 196 and 216 disposed in first and second feedback loops thereof, respectively.

Sense circuitry in FIG. 9 is configured to provide first mutual capacitance 170 and/or 174 between the first and second drive electrodes Dn+ and Dn− and the first sense electrode Sm+, and to provide a second mutual capacitance 172 and/or 176 between the first and second drive electrodes Dn+ and Dn− and the second sense electrode Sm−. As shown in FIG. 9, the first mutual capacitance(s) may be different from the second mutual capacitance(s). In one embodiment, such first or second mutual capacitance(s) may have magnitudes ranging between about 20 fF and about 1,000 fF, or between about 50 fF and about 300 fF. As further illustrated in FIG. 9, differential cell 150 may comprise shunt capacitances 162, 164, 166 and 168, and such shunt capacitances may range, by way of example, between about 100 fF and about 2,000 fF.

Drive lines Dn+ and Dn− are typically driven by square waves with frequencies ranging between about 50 kHz and about 200 kHz. In another embodiment, drive lines Dn+ and Dn− are typically driven by square waves with frequencies ranging between about 25 kHz and about 300 kHz. The rising and falling edges of the drive waveforms conduct through the mutual capacitors to the respective sense line inputs. The resulting sense line currents are proportional to the first time derivatives of the voltage drive waveforms. Each of operational amplifiers 191 and 212 integrates such currents to restore the original drive waveforms. Parallel resistors 196 and 216 leak charge to form high pass filters, and remove the drive waveform DC component. The outputs provided at the outputs of operational amplifiers 191 and 213 (neglecting the leak resistor) may be represented by the equation:

Vout=−Vdrive*Cm/Cf,

where Vdrive is the drive waveform with respect to signal ground, Cm is the mutual capacitance, and Cf is the feedback capacitor. The nominal DC value of Vout is Vref. In the example shown in FIG. 9, Vref=0.9V, Cf=1 pF, Vdrive=1.8V, and Cm is both 50 fF and 300 fF. The final output at M is a positive pulse of around 1V peak, where the two outputs from operational amplifiers 191 and 213 are combined, and where the common mode noise components from the two outputs cancel one another.

Those skilled in the art will now appreciate that there are many system architectures that can benefit from differential cell design. For example, in one embodiment, the drive lines can be driven by drive signals that sequentially drive one pair of drive electrodes at a time, and/or over a predetermined interval of time. In another embodiment, all differential lines may be driven simultaneously but at different frequencies. In still another embodiment, pairs of drive electrodes corresponding to individual cells comprising first and second drive electrodes may be driven simultaneously or sequentially. Differential cells 150 disclosed herein are agnostic to all such variations and embodiments, and offer enhanced performance with respect to conventional two port cells.

Referring now to FIGS. 5 through 9, at least some of individual cells 150 may comprise only single drive electrodes and single sense electrodes, and some of those cells 150 may be located at an edge of touchscreen or touch panel 90.

It will now be seen that the differential circuit topologies of individual cells 150 forming arrays of cells 150 in a touchscreen or touch panel 90 disclosed herein may be configured to cancel common mode noise appearing on the multiple sense lines contained in each cell, and can result in lower power consumption, enhanced touch or near-touch sensitivity for a touchscreen or touch panel, and increased immunity from noise.

Included within the scope of the present invention are methods of making and having made the various components, devices and systems described herein. For example, according to one embodiment there is provided a method of one or more of detecting touches or near-touches on a capacitive touchscreen or touch panel system sensing at least one touch or near touch of a finger, finger portion, hand or hand portion brought into proximity to the touchscreen, coupling common mode noise between first and second sense electrodes, driving pairs of drive electrodes corresponding to individual cells comprising first and second drive electrodes according to a predetermined sequence, driving pairs of drive electrodes for a predetermined period of time, driving simultaneously pairs of drive electrodes corresponding to individual cells comprising first and second drive electrodes, driving sequentially pairs of drive electrodes corresponding to individual cells comprising first and second drive electrodes, and driving each pair of drive electrodes corresponding to an individual cell comprising first and second drive electrodes at a frequency that is different from the frequencies at which other such pairs of drive electrodes are driven.

Various embodiments of the invention are contemplated in addition to those disclosed hereinabove. The above-described embodiments should be considered as examples of the present invention, rather than as limiting the scope of the invention. In addition to the foregoing embodiments of the invention, review of the detailed description and accompanying drawings will show that there are other embodiments of the present invention. Accordingly, many combinations, permutations, variations and modifications of the foregoing embodiments of the present invention not set forth explicitly herein will nevertheless fall within the scope of the present invention.

We claim:

1. A capacitive touchscreen or touch panel system, comprising:
a touchscreen comprising a first plurality of electrically conductive drive electrodes arranged in rows or columns, and a second plurality of electrically conductive sense electrodes arranged in rows or columns arranged at an angle with respect to the rows or columns of the first plurality of electrodes, mutual capacitances existing between the first and second pluralities of electrodes at locations where the first and second pluralities of electrodes intersect to form individual cells, the mutual capacitances changing in the presence of one or more fingers or touch devices brought into proximity thereto;
drive circuitry operably connected to the first plurality of drive electrodes, and
differential voltage sense circuitry operably connected to the second plurality of sense electrodes;
wherein at least some of the individual cells each comprise first and second drive electrodes and first and second sense electrodes corresponding thereto, the first and second drive electrodes being driven by a drive signal delivered thereto by the drive circuitry, the first and second sense electrodes being operably and separately connected to corresponding first and second input terminals of first and second amplifier circuits forming a portion of the sense circuitry, first and second sense signals appearing on the first and second sense electrodes in response to the drive signal being provided to the first and second drive electrodes, the sense circuitry further being configured to differentially combine first and second outputs provided by the first and second amplifier circuits and thereby cancel substantially common mode noise components present in the drive signal.

2. The touchscreen or touch panel system of claim 1, wherein the first and second amplifier circuits further comprise first and second operational amplifiers, respectively.

3. The touchscreen or touch panel system of claim 2, wherein the first and second inputs are provided to inverting inputs of the first and second operational amplifiers, respectively.

4. The touchscreen or touch panel system of claim 2, wherein a reference voltage is provided to positive inputs of the first and second operational amplifiers, respectively.

5. The touchscreen or touch panel system of claim 2, wherein the first and second operational amplifier circuits are each further configured as integrating circuits.

6. The touchscreen or touch panel system of claim 5, wherein the first and second operational amplifier circuits each comprise first and second feedback capacitors disposed in first and second feedback loops thereof, respectively.

7. The touchscreen or touch panel system of claim 1, wherein the sense circuitry is further configured to provide a first mutual capacitance between the first and second drive electrodes and the first sense electrode.

8. The touchscreen or touch panel system of claim 1, wherein the sense circuitry is further configured to provide a second mutual capacitance between the first and second drive electrodes and the second sense electrode.

9. The touchscreen or touch panel system of claims 7 and 8, wherein the first mutual capacitance is different from the second mutual capacitance.

10. The touchscreen or touch panel system of claim 7 or 8, wherein the first or second mutual capacitance has a magnitude ranging between about 20 fF and about 1,000 fF.

11. The touchscreen or touch panel system of claim 1, wherein at least some of the individual cells further comprise shunt capacitances.

12. The touchscreen or touch panel system of claim 1, wherein magnitudes of the shunt capacitances range between about 100 fF and about 2,000 fF.

13. The touchscreen or touch panel system of claim 1, wherein the drive signal has a frequency ranging between about 25 kHz and about 300 kHz.

14. The touchscreen or touch panel system of claim 1, wherein the common mode noise is capacitively coupled between the first and second sense electrodes.

15. The touchscreen or touch panel system of claim 1, wherein a magnitude of the common mode noise ranges between about 2 pF and about 100 pF.

16. The touchscreen or touch panel system of claim 1, wherein at least some of the individual cells comprise only single drive electrodes and single sense electrodes.

17. The touchscreen or touch panel system of claim 16, wherein at least some of the individual cells comprising single drive electrodes and single sense electrodes are located at an edge of the touchscreen or touch panel

18. The touchscreen or touch panel system of claim 1, wherein pairs of drive electrodes corresponding to individual cells comprising first and second drive electrodes are driven according to a predetermined sequence.

19. The touchscreen or touch panel system of claim 18, wherein the pairs of drive electrodes are driven for a predetermined period of time.

20. The touchscreen or touch panel system of claim 1, wherein pairs of drive electrodes corresponding to individual cells comprising first and second drive electrodes are driven simultaneously.

21. The touchscreen or touch panel system of claim 1, wherein pairs of drive electrodes corresponding to individual cells comprising first and second drive electrodes are driven sequentially.

22. The touchscreen or touch panel system of claim 1, wherein each pair of drive electrodes corresponding to an individual cell comprising first and second drive electrodes is driven at a frequency that is different from the frequencies at which other such pairs of drive electrodes are driven.

23. A method of detecting touches or near-touches on a capacitive touchscreen or touch panel system comprising a touchscreen comprising a first plurality of electrically conductive drive electrodes arranged in rows or columns, and a second plurality of electrically conductive sense electrodes arranged in rows or columns arranged at an angle with respect to the rows or columns of the first plurality of electrodes, mutual capacitances existing between the first and second pluralities of electrodes at locations where the first and second pluralities of electrodes intersect to form individual cells, the mutual capacitances changing in the presence of one or more fingers or touch devices brought into proximity thereto, drive circuitry operably connected to the first plurality of drive electrodes, and differential voltage sense circuitry operably connected to the second plurality of sense electrodes, wherein at least some of the individual cells each comprise first and second drive electrodes and first and second sense electrodes corresponding thereto, the first and second drive electrodes being driven by a drive signal delivered thereto by the drive circuitry, the first and second sense electrodes being operably and separately connected to corresponding first and second input terminals of first and second amplifier circuits forming a portion of the sense circuitry, first and second sense signals appearing on the first and second sense electrodes in response to the drive signal being provided to the first and second drive electrodes, the sense circuitry further being configured to differentially combine first and second outputs provided by the first and second amplifier circuits and thereby cancel substantially common mode noise components present in the drive signal, the method comprising sensing at least one touch or near touch of a finger, finger portion, hand or hand portion brought into proximity to the touchscreen.

24. The method of claim 23, wherein a first mutual capacitance is provided between the first and second drive electrodes and the first sense electrode.

25. The method of claim 23, wherein a second mutual capacitance is provided between the first and second drive electrodes and the second sense electrode.

26. The method of claims 24 and 25, wherein the first mutual capacitance is different from the second mutual capacitance.

27. The method of claim 23, further comprising capacitively coupling the common mode noise between the first and second sense electrodes.

28. The method of claim 23, further comprising driving pairs of drive electrodes corresponding to individual cells comprising first and second drive electrodes according to a predetermined sequence.

29. The method of claim 28, further comprising driving the pairs of drive electrodes for a predetermined period of time.

30. The method of claim 23, further comprising driving simultaneously pairs of drive electrodes corresponding to individual cells comprising first and second drive electrodes.

31. The method of claim 23, further comprising driving sequentially pairs of drive electrodes corresponding to individual cells comprising first and second drive electrodes.

32. The method of claim 23, further comprising driving each pair of drive electrodes corresponding to an individual cell comprising first and second drive electrodes at a frequency that is different from the frequencies at which other such pairs of drive electrodes are driven.
